(19) United States
(12) Patent Application Publication
(10) Pub. No.: US 2021/0149134 A1
(43) Pub. Date: May 20, 2021

(54) Reversible Electrical Connector with Reversible Optical Connections

(71) Applicant: Joseph Lai, Torrance, CA (US)

(72) Inventor: Joseph Lai, Torrance, CA (US)

(21) Appl. No.: 16/687,172

(22) Filed: Nov. 18, 2019

(51) Int. Cl. G02B 6/42; H04B 10/25

(52) U.S. Cl. CPC G02B 6/4292; H01R 24/64; H04B 10/2504; G02B 6/423

(57) ABSTRACT

Old and new standard, regular electrical-only, non-optical connectors, such as USB, Lightning, HDMI, Ethernet, are modified for migrating into new optical capabilities. These electrical-only connectors are integrated with active microelectronic/optical conversion components inside for converting electrical signals to optical signals and optical signals back to electrical signals. Newly integrated connectors are 100% physically and functionally compatible with the original electrical-only connectors which have the same sizes, colors, shapes, cut-outs, mating cavities, mounting holes, pins and foot-prints can directly replace the old connectors to install onto the same surface-mount pads, through-holes of PCB of existing product designs. The newly invented connectors are for phone/computer/video/camera/storage/network equipment manufacturers to easily adopt and assemble their products with new optical connectivity for tremendous performance improvement in bandwidth, distance and reversibility with lowest cost for both wired and wireless optical applications.

### CROSS-REFERENCES

This application incorporates by reference the U.S. patent application Ser. No. 14/562,640 “User-Friendly USB Connector with Optical Connection” in its entirety and U.S. Provisional Patent application 62/917,049 “USB Connectors with Active Optical Components”, Joseph Lai is the sole inventor of the U.S. patent application Ser. No. 14/562,640 and Provisional Patent application 62/917,049, the invention is disclosed in this application.

### FIELD OF THE INVENTION

This present invention is related to smarter, faster, longer distance and cheaper ways of making new connectors with integrated active electrical and optical components, implementing with modern packaging technologies for adding new optical connections based on standard existing, old electrical-only connectors for personal computing, smartphones, camera/video, data storage, networking and all suitable applications.

### BACKGROUND OF THE INVENTION

Why is this invention necessary?

### The Problems

Old electrical data signal transmission lines are too slow, too expensive with very short distance. Making modern electronics products, such as smartwatches, wearables, smartphones, personal computers/tablets, video cameras, storage and/or networking devices are difficult, it costs tremendous money to engineer and make them. Portable electronics products such as phones, watches are miniaturized at the smallest size for its best portability. Typical printed circuit boards (PCB or PC Boards) are already stuffed with massive integrated components with complicated, expensive multiple layers and flexible materials. For high speed, high bandwidth circuitries, radio frequency interference (RFI) and electro-magnetic interference (EMI) concerns are also making the packaging task very difficult to change good products which have already been designed. Changing the design from totally electrical connection to optical has not being done for popular electronics devices yet. New connectors such as the type-C has the small foot-print but just can not deliver the data for today's demanding of higher bandwidth.

Meanwhile, old standard connectors are replaced by USB type-C connectors, Type A, Type B, micro USB, Display port, Thunderbolt, Lightning and HDMI are all becoming obsolete with new type C but there is absolutely no improvement for the type C performances.

For example, new 8K (7680×4320 pixels) smart TVs are coming, HDMI has adopted USB type-C connectors, it is estimated to deliver 8K non-compressed video requires around 80 Gbps of bandwidth but type-C with electrical connections are only good for up to 10 Gbps at 1 Meter (3.3 ft.) distance.

There are AOC (Active Optical Cable) products for HDMI and type C, trying to solve some of the problems, however, AOC products put chips in the cables; are ugly, bulky, expensive, harder to make/upgrade and easy to damage with very limited success so far.

### The Inventor's Solution

Integrating the high-speed, high-bandwidth active optical components, the optical/electrical driver chip, the photo diode and laser Vcsel (Vertical Cavity Surface Emitting Laser) diode inside the regular standard connector which not only converts the electrical signal to optical, optical signal back to electrical but also maintaining its backward compatibilities of the old regular standard electrical connectivity functionalities.

### SUMMARY OF THE INVENTION

This present invention further improves the applicant old invention of “User-Friendly USB Connector with Optical Connection” with active components installed inside the regular electrical connector which contains optical to electrical driver, electrical to optical driver plus interface photo diodes for receiving and laser diode for transmitting the optical signals.

Why put the active optical components inside of the regular electrical connector?
1. Got lot of space inside the connectors; it really doesn't need much space to place today's active optical conversion micro-electronics components inside the above mentioned standard electrical-only connectors. Typical transceiver dies are small around 1 mm by 1 mm, laser/photo diodes are 0.25 mm×0.25 mm.
2. Got all the required signals and power supply lines already inside connectors for electrical to optical conversion active components; no extra outside connections are required. USB, Lightning, HDMI, Ethernet (PoE) all have built-in power.
3. Got very limited space outside the connectors; the PC Boards with the regular electrical connectors are normally already extremely crowded with massive components onboard and very hard to find space for laying out both active optical components and passive components.
4. Easier to make than optical-only connectors; making active components inside electrical connector is easier than drilling/molding tiny holes to place fiber-optics inside the connectors, so no small fiber-optics linking from optical components on mother board to the connector, no optical lenses, no terminations, no reflecting mirrors, no need to polish both ends and easier for alignment from laser diode/photo diode to fiber of the cable compares to fiber to fiber butt-couplings.
5. Easier to make than AOC (Active Optical Cable) connectors; making active components inside the AOC plug connectors require bulky, expensive housing, large PC board, optical lenses, reflecting mirrors and difficult to align from laser diode/photo diode to fiber.
6. Easier to make than original electrical-only connectors; converted new combo connector can be easier to make (than some regular electrical connectors) with present invention of using flexible PC Board instead of expensive metal stamping or metal etching process.
7. No need to change anything for existing products; same old design PCB layout and same product housing/enclosure/chassis; integrated new electrical/optical connectors are 100% compatible with the old standard electrical-only connectors, it is very easy for design engineers and manufacturing engineers to convert their old non-optical connectable products to become a new optical equipped. It saves tremendous NRE (Non-Recurring Engineering) time and money.
8. Totally compatible to the old standards; Converted new combo connectors are having the same capability of the original electrical functions; it is 100% physically and functionally downward compatible, therefore, no need to throw away old design and equipment.
9. Easy to upgrade; when new faster, cheaper, better active electrical/optical components become available, new active optical components will be easily made same way to replace the old connectors instead of replacing whole mother boards.
10. Faster and goes farther; converted new combo connection with optical fiber is at least 100× of bandwidth with at least 100× of extra distance.
11. Great for extreme fast speed; integrated and miniaturized connectors have better performance with less RFI and EMI to shield, to induce, to generate/radiate and less attenuation of signals can carry higher frequency of signals as the length of both fiber and electrical signal wires are significantly reduced.
12. Better for dissipating heat; connectors are normally located near edge/outside of the enclosure, therefore, less chance for overheating active optical components.
13. Marketing dream comes true; Phone/Computer/Video/Storage/Networking devices manufacturers can now easily jump on with no cost of investment for engineering of new optical products and market and advertise their old products with new features of optical connectivity for much more profits.
14. Looks and feels great; better aesthetically appearances of smaller and shorter plug connectors on both ends of cable compare to AOC (Active Optical Cables) have dongle-like plugs which are ugly, big, heavy, bulky, lengthy and easy to damage.
15. Saves money; It cost much less to make the conversion inside regular electrical connector instead of making it outside (both on motherboard or as an AOC). The upgradeability also saves tremendous.
16. The best way to upgrade and migrate; for whatever reasons, change is not easy, electrical connections are too old, too expensive, too slow, too heavy, too bulky, shorter distance, corrosive, toxic and present bad EMI/RFI problems for carrying high-speed data. It is time to move on to new optical applications.

### BRIEF DESCRIPTION OF THE DRAWINGS

FIG. 1A. (Prior Art) Regular USB type-C male plug connector has no capability of optical functions.

FIG. 1B. (Prior Art) Regular USB type-C female receptacle connector has no capability of optical functions.

FIG. 1C. (Prior Art) Front view of regular USB type-C female receptacle connector has no capability of optical functions.

FIG. 1D. (Prior Art) Front view of regular USB type-C male plug connector has no capability of optical functions.

FIG. 1E. (Prior Art) Side view of regular USB type-C female receptacle connector has no capability of optical functions.

FIG. 1F. (Prior Art) Side view of regular USB type-C male plug connector has no capability of optical functions.

FIG. 2A. (Prior Art) Applicant “User-Friendly USB Connector with Optical Connection” has no active components inside the regular USB type-C female receptacle connector.

FIG. 2B. (Prior Art) Applicant “User-Friendly USB Connector with Optical Connection” has no active components inside the regular USB type-C male plug connector.

FIG. 2C. (Prior Art) Side view of applicant “User-Friendly USB Connector with Optical Connection” has no active components inside the regular USB type-C female receptacle connector.

FIG. 2D. (Prior Art) Side view of applicant “User-Friendly USB Connector with Optical Connection” has no active components inside the regular USB type-C male plug connector.

FIG. 2E. (Prior Art) Front view of applicant “User-Friendly USB Connector with Optical Connection” has no active components inside the regular USB type-C female receptacle connector without housing.

FIG. 2F. (Prior Art) Front view of applicant “User-Friendly USB Connector with Optical Connection” has no active components inside the regular USB type-C male plug connector without housing.

FIG. 3A. (Prior Art) Optical Connection has no active components inside but has the fiber-optics installed on the type-C female receptacle connectors.

FIG. 3B. (Prior Art) Optical Connection has no active components inside but has the fiber-optics installed on the type-C male plug connectors

FIG. 3C. (Prior Art) Optical Connection has no active components with male plug mates into female receptacle.

FIG. 4A. An example for active components installed inside type-C female receptacle.

FIG. 4B. An example for active components installed inside type-C male receptacle.

FIG. 4C. An example for active components installed inside type-C female connector plug-in halfway with the male plug.

FIG. 4D. An example for active components installed inside type-C female receptacle and male plug completely mated on a PC board.

FIG. 4E. Front view of female receptacle with active optical components.

FIG. 5A. A more detailed example for active components installed on a FPC for a type-C female receptacle connector with the conducting traces.

FIG. 5B. A more detailed example for active components installed on a FPC for a type-C female receptacle connector without the conducting traces.

FIG. 5C. A more detailed example for active components installed on a FPC for a type-C female receptacle viewing from the side.

FIG. 6A. An example for active components installed inside of Ethernet RJ45.

FIG. 6B. An example for active components installed inside of TV HDMI connectors.

FIG. 7A. An electrical to optical/optical to electrical transceiver chip in die form.

FIG. 7B. A photo diode in die form.

FIG. 7C. A laser diode in die form.

### DETAIL DESCRIPTIONS

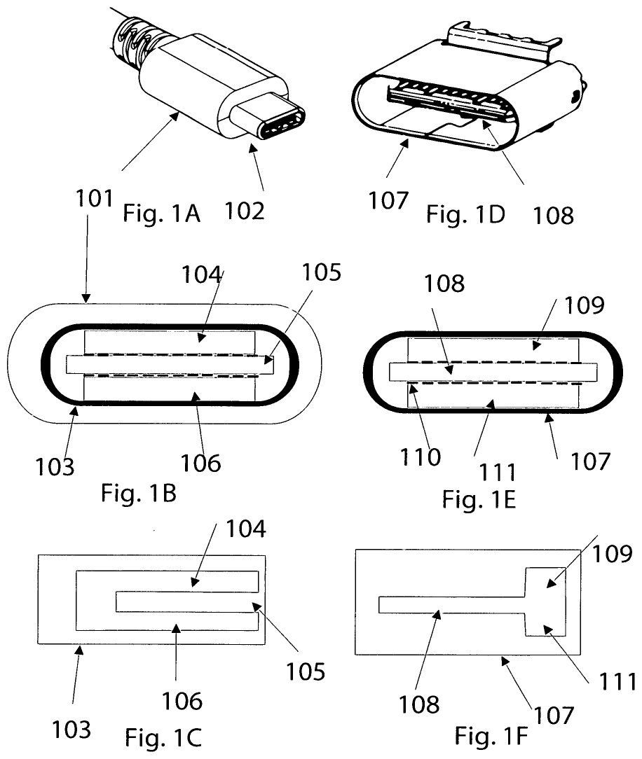

FIG. 1A-1F contain prior art of the newly developed non-optical USB type-C connectors. FIG. 1A shows the male plug on the cable with plastic holder (101) and the USB type-C connector 102. FIG. 1B shows the front view of the male plug of USB type-C which has spacers (104) on top and (106) on bottom. (105) is the cavity to allow the female tongue (108) to go in and mate. (103) is the oval-shaped metal housing which protects and shield the plastic and all metal pins.

FIG. 1C is an X-ray side view, from this angle, inside USB type-C (104) and (106) forms a horseshoe to allow reversibility with contact pins on both top (104) and bottom (106).

FIG. 1D shows a 3D view of the USB type-C female receptacle. (108) is the floating tongue with metal housing (107) for (103) to mate into. FIG. 1E shows the front view of the USB type-C female receptacle with a floating tongue (108) right in the middle supported by spacers (109) on top and (111) on bottom and put together within the metal housing (107). (110) is one of the contact pins for making electrical connections. Two rows of 12 pins are shown, but only one row is necessary for connecting the USB type-C male plug and female receptacle. The male plug has 24 pins with 12 on top and 12 on bottom as reversibility requires. FIG. 1F is an X-ray side view of the USB type-C female receptacle with the floating tongue (108) for mating with the horseshoe of the male plug of the USB type-C male plug.

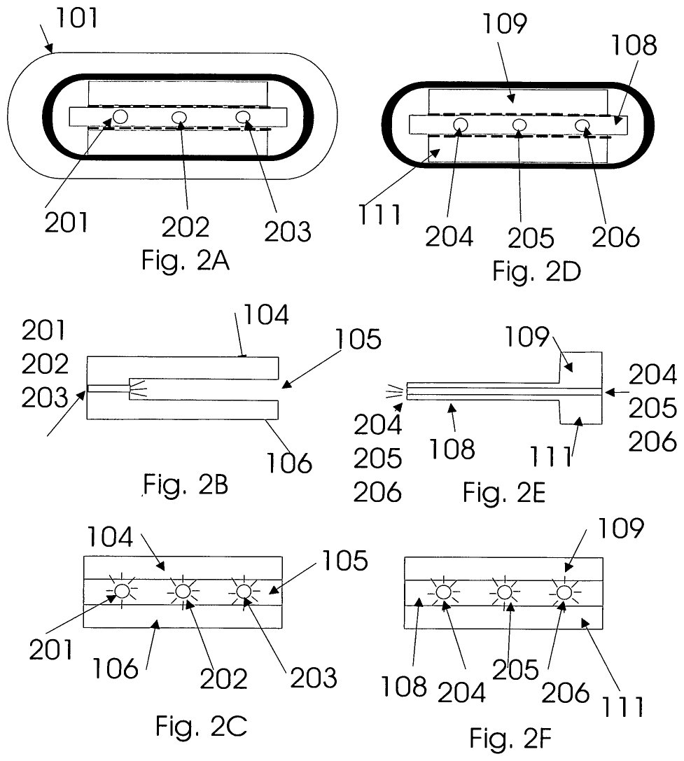

FIG. 2A-2F (Prior Art) show the inventor's previous patent application of a USB type-C connector modified for fiber-optic capability, FIG. 2A shows the USB type-C male plug now equipped with 3 holes (201) (202) (203) for fiber-optic connections. FIG. 2B shows the side view of the USB type-C male plug without metal housing. It looks like a horseshoe with cavity (105) with supports (104) and (106). The holes or optical inlets/outlets are in the back of the horseshoe (201) (202) and (203). FIG. 2C is the front view of the USB type-C male plug with the fiber-optic inlet/out holes (201) (202) and (203). FIG. 2D is the USB type-C female receptacle with equipped inlet/outlet holes (204) (205) (206) on the tip of the tongue (108). FIG. 2E shows the side view of the USB type-C female receptacle without metal housing with inlet/out holes (204) (205) (206) equipped from back to the tip on the tongue (108) and supported by base spacers (109) on top and (111) on bottom. FIG. 2F shows the front view of the USB type-C female receptacle which has the inlet/outlet holes (204) (205) (206) on the tip of the tongue (108) and supported by base spacers (109) on top and (111) on bottom.

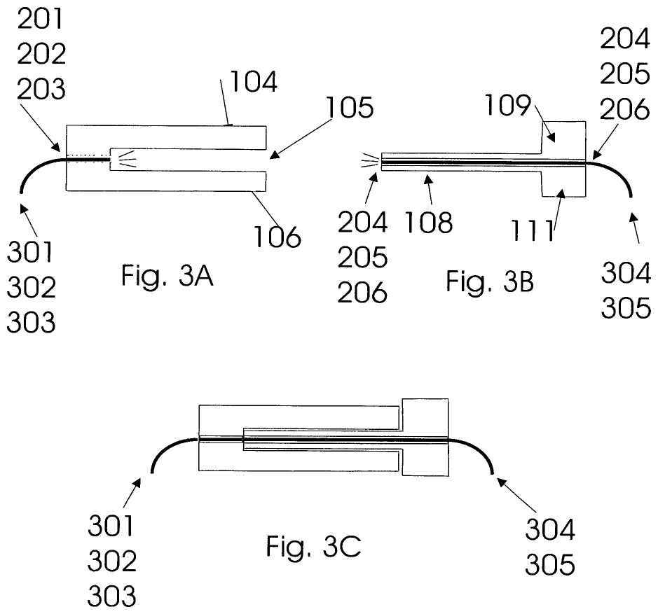

FIG. 3A-3C (prior art) shows how the USB type-C male plug and the USB type-C female receptacle connector mate and make not only electrical connections (as type-C's normal specifications) but also making fiber-optic connections as well. FIG. 3A is the USB type-C male plug horseshoe shaped with holes provided (201) (202) (203) on the plastic holder without metal housing. FIG. 3B is the USB type-C female receptacle with (204) (205) (206) through-hole channels on the tip of tongue. FIG. 3C shows the male plug and female receptacle mate with fiber-optic conductors (301) (302) (303) and (304) (305). Since the USB type-C is reversible, for half-duplex operation, only hole (202) in the middle on the USB type-C male plug and a hole (205) also in the middle on the USB type-C female receptacle is necessary which is plenty bandwidth for normal users with reversibility. For full-duplex operation, additional holes are required as hole (202) always mates with hole (205) but for the full-duplex operation, one more pair of holes is required. In the normal mated position, hole (201) mates with (206) but in the reverse position, hole (201) will mate with hole (204). It is suggested that fiber-optic conductors with male plug have 2 fiber-optic conductors but the female receptacle on the computer has 3 fiber-optic conductors to save cost.

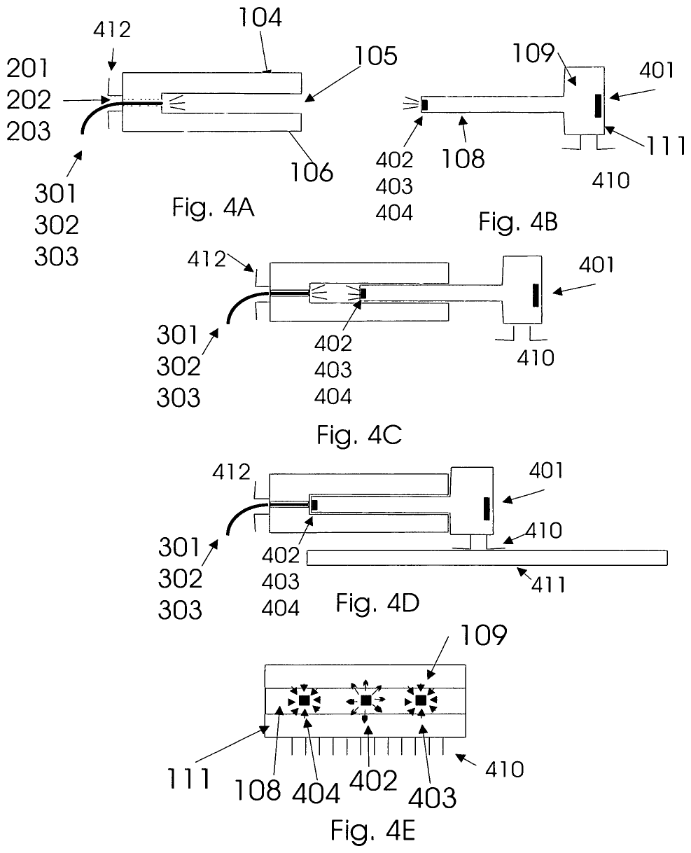

FIG. 4A-4E show the new invention of installing the active components (401) (402) (403) (404) inside the type-C connector. Please notice no more pigtails of fiber-optics go into the connector. (401) is the transceiver chip and (402) is the Vcsel (Vertical Cavity Surface Emitting Laser) laser diode and (403) (404) are the photo detector diodes. FIG. 4A shows the male plug of the optical connector with original metal pins (412) for backward compatible to electrical signal and power connections, FIG. 4B shows the female receptacle with the transceiver chip (401) and Vcsel (Vertical Cavity Surface Emitting Laser) (402) and photo diode (PD) (403) (404) without fiber-optic pigtails. FIG. 4C show the male and female half way mate as an illustrating of free space optical communication (FSO) application for LiFi, IrDA type of wireless optical connectivity. FIG. 4D shows male (FIG. 4A) and female (FIG. 4B) fully mated. FIG. 4E shows the front view of the female receptacle (108) is the tongue with (109) (111) as the base. Fiber-optic inlet/outlet holes (204) (205) (206) of FIG. 2D, FIG. 2E and FIG. 2F are replaced with optical components Vcsel (Vertical Cavity Surface Emitting Laser) laser diode (402) in the middle for transmitting optical signals and two photo diodes (PD) (403) (404) receiving optical signals right on the tip of tongue (108). This design makes the reversible compatibility for applications of type-C. (410) shows the legs or contact pins of the electrical connector to supply the signal and power to the active components, transceiver chip and laser/photo diodes. (410) legs are surface mounted, soldered and assembled onto a PC board (411) for a final product.

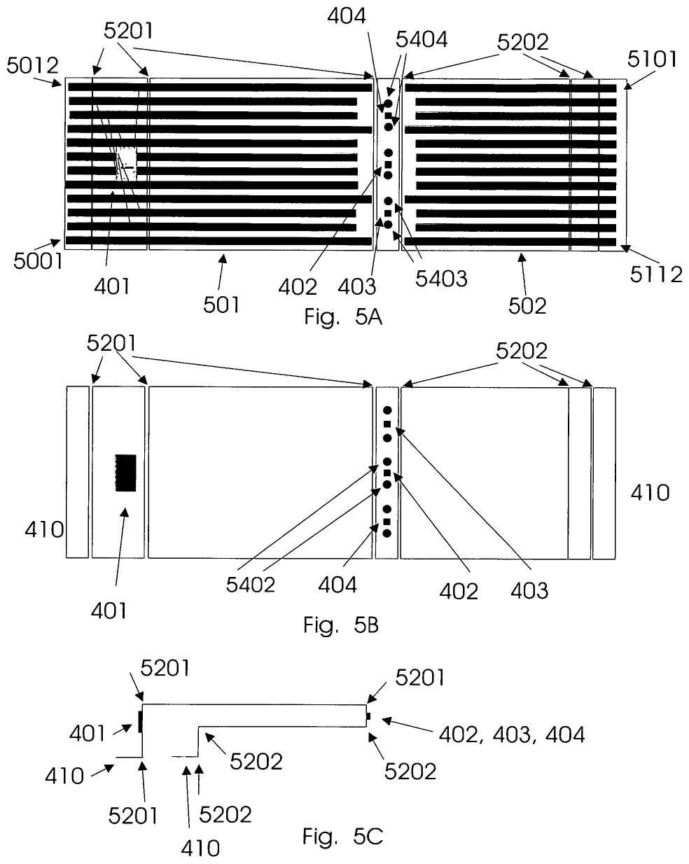

FIG. 5A-5C show the new invention of installing and integrating the active component inside the standard USB type-C female receptacle connector. For easier of making the USB type-C female receptacles with optical fiber connections in mass production, this optical/electrical combo connector uses a flexible PC Board (FPC) to make it. The flexible PC Board can be made of a polyimide film as thin as 1 mil (1000th of an inch) then wrapping and folding around to a non-conductive such as FR-4 material substrate to make it rigid so it can insert into the male plug with optical fiber of cables. FIG. 5A shows layout of FPC before folding.

For maintaining type-C reversibility, symmetrical PCB traces are required (501) is the substrate on the left and (502) is on the right before folding.

For type-C standard electrical connections (5001 to 5012) with total 12 PC board copper traces on left side of the layout, (5101 to 5112) with another 12 traces are on the right. The transceiver chip (401) is die-bonding to the traces on the right to connect to power and signal lines. Laser diode Vcsel (Vertical Cavity Surface Emitting Laser) (402) is placed in the center with two photo diodes (403 404) nearby. Flexible PC (FPC) technology is adopted for easier fabrication compares to metal-stamping of the new combo connector. Electrical and optical combined are necessary for certain applications but not for others which are only require optical.

The FPC with three folding lines (5201) on the left becoming top of the new combo connector is folded with three additional folding lines (5202). All folding-lines are 90 degree as show FIG. 5C. After folding, Laser diode (402) and two photo diodes (403) (404) are facing front and the transceiver chip (401) is facing back. Notice the legs of the connector (410) are connected through traces of the FPC for surface-mount assembly. FIG. 5B shows the design without the electrical connections as an optical-only connector based on type-C form-factor and layout.

Round dots (5402 5403 5404) are bonding pads on FPC for the photo diodes and laser diode. To make this connector reversible, 2 photo diodes and 1 laser diode Vcsel (Vertical Cavity Surface Emitting Laser) are used. The cable has only one fiber-optic for transmitting and one fiber-optic for receiving the optical signals for full-duplex transmission and just one fiber-optic for either half-duplex or simplex applications such as HDMI.

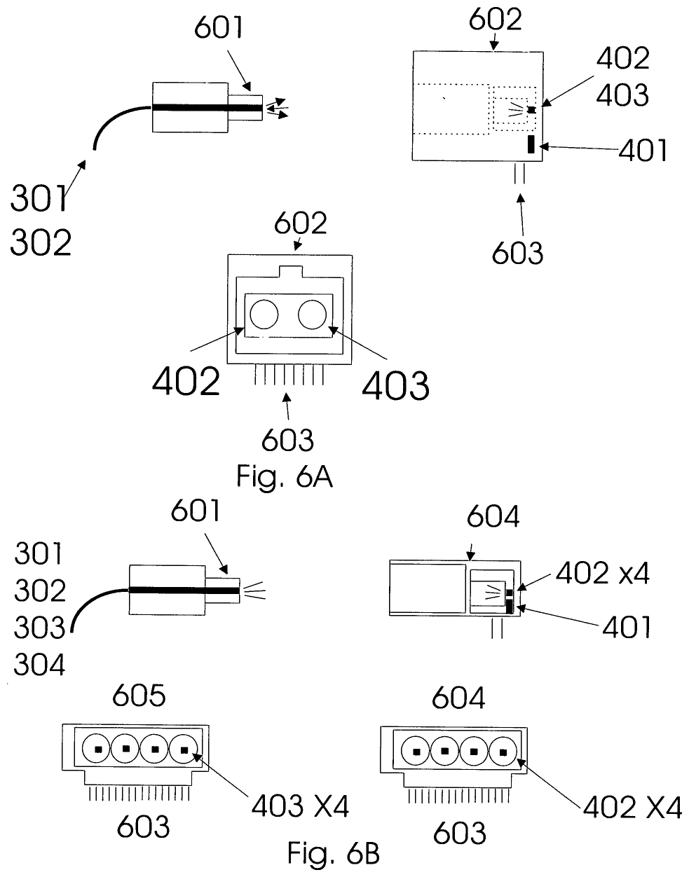

FIGS. 6A and 6B show other examples of optical over electrical connectors for RJ45 of Ethernet and HDMI of smart TV. Popular optical transmitting and receiving modules (TOSA, ROSA or BOSA) are connecting to common LC/SC ferrules of fiber-optic cables.

FIG. 6A shows the RJ45 conversion transceiver chip (401) embedded inside the (602) RJ45 housing with (402) as transmitting laser diode and (403) as receiving photo diode. (603) has the pins or legs to solder to the PC board of the products. (601) has the LC/SC type of optical fiber ferrule with pigtails (301) (302) connecting and delivering optical data to the other end of applications.

FIG. 6B shows the HDMI type of conversion, only transmitting chip (401) is required inside housing (604) as HDMI is a simple one way connection with transmitter on the set-top boxes computers, DVD/BluRay players or camera devices and the TV/monitor is a receiving only device. However, due to the tremendous bandwidth delivered, 4 channels of Vcsel laser diodes (402) are required for RGB and sync signals. (605) is the housing at receiving end for the TV or computer monitor with 4 channels of photo diodes (403×4) for receiving the signals. (301) (302) (303) (304) are pigtails of fiber-optics of transmission signals. This example is taking advantage of popular old SC/LC/ST type of connectors with fiber-optics at very low-cost without re-designing a new optical fiber cable.

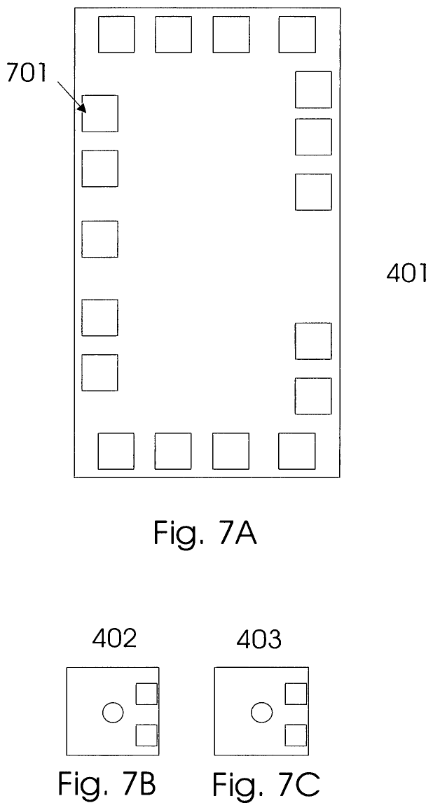

FIG. 7A shows the typical transceiver chip (401) made in die form with bonding pads (701). Die-bonding is necessary as the packaged chips are too big to fit inside the USB type-C female receptacle and other connectors. FIG. 7B shows the typical laser Vcsel (Vertical Cavity Surface Emitting Laser) transmitting diode (402) and FIG. 7C shows photo detector (PD) receiving diode (403) in die form same dimension has the bonding pads on the die. Laser and photo diodes are precisely picked and placed, die-bonded then molded onto the PC boards without complicated process of using optical lenses, mirrors, alignment tools for low-cost mass productions. Transceiver dies are small around 1.29 mm by 0.74 mm, laser/photo diodes are smaller around 0.235 mm×0.235 mm. Thickness is around 0.125 mm.

### CONCLUSION

Optical connections are necessary for today's applications of electronics equipment. Optical connections have to replace electrical connections applications demanding high bandwidth data with longer distance transmission ranges. Active components installed inside the existing standard electrical connector is the best way to make it happen.

### WARNING

Safety first! Please do not pointing strong light, visible or invisible, such as laser beams toward anybody or any animal. Please wear safety goggles to protect your eyes when working on lasers for this present invention.

1-20. (canceled)

21: A reversible electrical connector with fiber optic connections, comprising:
a) a reversible body with an internal space,
b) a plurality of electrical pins,
c) an electrical to optical signal amplifier,
d) a laser VCSEL diode, and
e) an optical signal outlet on said body,
whereby said electrical to optical signal amplifier and laser diode inside said body of said reversible electrical connector provide electrical to optical signal conversion from said electrical pins to said optical signal outlet for transmitting optical signals for telecommunication applications.

22: The reversible electrical connector with fiber optic connections in claim 21, wherein said fiber optic connections can be incorporated into USB type-C and/or Lightning connectors.

23: The reversible electrical connector with fiber optic connections in claim 21, wherein said optical signal outlet is usable to mate with industry standard LC, SC and/or ST optical connectors.

24: The reversible electrical connector with fiber optic connections in claim 21, wherein said electrical to optical signal amplifier is internally connected to said electrical pins and integrated inside said body of said reversible electrical connector.

25: The reversible electrical connector with fiber optic connections in claim 24, wherein said pins of said reversible electrical connector with fiber optic connections are identical to original pins layout of original reversible non-optical connector.

26: The reversible electrical connector with fiber optic connections in claim 21, wherein said optical signal outlet is placed in center of said reversible body can allow users to plug-in mating connectors in either normal at 0 degree or reversed at 180 degree positions.

27: A reversible electrical connector with fiber optic connections, comprising:
a) a reversible body with an internal space,
b) a plurality of electrical pins,
c) an optical to electrical signal amplifier,
d) two photo diodes, and
e) two optical signal inlets on said body,
whereby said optical to electrical signal amplifier and photo diodes inside said body of said electrical connector provide optical to electrical signal conversion from said optical signal inlets to said electrical pins for receiving optical signals for telecommunication applications.

28: The reversible electrical connector with fiber optic connections in claim 27, wherein said fiber optic connections can be incorporated into USB type-C or Lightning connectors.

29: The reversible electrical connector with fiber optic connections in claim 27, wherein said optical signal inlets are usable to mate with industry standard LC, SC and/or ST optical connectors.

30: The reversible electrical connector with fiber optic connections in claim 27, wherein said optical to electrical signal amplifier is internally connected to said electrical pins and integrated inside said body of said reversible electrical connector.

31: The reversible electrical connector with fiber optic connections in claim 30, wherein said pins of said reversible electrical connector with optical connections are identical to original pins layout of original reversible non-optical connector.

32: The reversible electrical connector with fiber optic connections in claim 27, wherein said two optical signal inlets are symmetrically placed near edge of said reversible body can allow users to plug-in mating connectors in either normal at 0 degree or reversed at 180 degree positions.
